(19) United States
(12) Patent Application Publication
(10) Pub. No.: US 2026/0358982 A1
(43) Pub. Date: Nov. 12, 2026

(54) LIFECYCLE MANAGEMENT OF OBJECTS MAINTAINED IN A MULTI-TENANT OBJECT STORAGE

(71) Applicant: Oracle International Corporation, Redwood Shores, CA (US)

(72) Inventors: Nandini Singhal, Bengaluru (IN); Kevin Canuette Grimaldi, Burlington, MA (US)

(21) Appl. No.: 19/199,466

(22) Filed: May 6, 2025

(51) Int. Cl. G06F 3/06

(52) U.S. Cl. CPC G06F 3/067; G06F 3/0604; G06F 3/0644

(57) ABSTRACT

According to an aspect of the present disclosure, a (scheduler) system picks a bucket of objects corresponding to a tenant, the bucket containing objects belonging to the tenant. The system scans sequentially the objects in the (picked) bucket to determine a target object that requires an LCM action to be performed and adds the target object to a set of target objects. The system continues the scanning and the adding until a count of objects in the set of target objects equals a threshold (N). The system then marks the set of target objects for LCM processing. According to another aspect, the system splits the objects in the (picked) bucket into multiple partitions and then processes (scan, add, continue actions noted above) in parallel, the multiple partitions to find the set of target objects for the picked bucket.

### BACKGROUND OF THE DISCLOSURE

### Technical Field

The present disclosure relates to cloud computing and more specifically to lifecycle management of objects maintained in a multi-tenant object storage.

### Related Art

Multi-tenant architecture is often employed in cloud computing, whereby a cloud infrastructure (containing hardware and software resources) is used to serve multiple customers, known as tenants, while maintaining data isolation and security for each tenant as is well known in the relevant arts. As a result, each tenant has the flexibility to specify the specific resources and the scale of such resources, as required (possibly as a function of time). In addition, data security is also provided since users of a tenant have potential visibility into only the data corresponding to the tenant but not of other tenants by design of the multi-tenant architecture.

Object storage hosted in such a multi-tenant architecture is a common resource served to multiple tenants. The object storage enables the tenants to store their relevant data in the form of one or more objects. As is well known, each object typically contains one or more attributes associated with corresponding values, is associated with some metadata (describing the attributes/object), and is identified by a unique identifier. Data isolation and security for the objects stored by different tenants may be implemented using techniques such as authentication, authorization, access control, etc. as is well known in the relevant arts.

Lifecycle management (LCM) refers to a feature that allows a tenant to define rules for managing the storage and deletion of objects maintained in the object storage. Each tenant specifies desired policies that specify actions to be taken on objects based on their age or access patterns. Such actions may include transitioning objects to different storage classes such as primary, backup, archive, etc. or deleting the objects after a certain period.

A provider of the multi-tenant object storage (such as a cloud provider providing the cloud infrastructure) typically supports such lifecycle management of objects by accepting LCM policies specified by different tenants and applying these policies to their objects maintained in the object storage (commonly as a background service). Applying an LCM policy may entail checking whether any condition(s) specified in the LCM policy are satisfied for each object belonging to the tenant, and if satisfied, performing the actions specified as part of the LCM policy.

It may be appreciated that challenges (e.g., fairness, efficiency, etc.) may be presented when the number of objects maintained by a tenant becomes substantively large (for example, more than a billion objects) or when the distribution of the objects is non-uniform (one tenant having a few thousand objects vs another tenant having a million objects).

Aspects of the present disclosure are directed to life cycle management of objects maintained in a multi-tenant object storage, in particular to address the scenarios noted above.

### BRIEF DESCRIPTION OF THE DRAWINGS

Example embodiments of the present disclosure will be described with reference to the accompanying drawings briefly described below.

FIG. 1 is a block diagram illustrating an example computing environment in which several aspects of the present disclosure can be implemented.

FIG. 2A illustrates the manner in which clouds for multiple tenants are deployed across nodes of computing infrastructures in one embodiment.

FIG. 2B illustrates the manner in which multiple tenants are enabled to store objects in their clouds in one embodiment.

FIG. 2C illustrates the manner in which lifecycle management of objects is implemented in one embodiment.

FIG. 3 is a flow chart illustrating the manner in which lifecycle management of objects maintained in a multi-tenant object storage is facilitated according to aspects of the present disclosure.

FIG. 4 is a block diagram illustrating the manner in which lifecycle management of objects maintained in multi-tenant object storages is facilitated in one embodiment.

FIG. 5 is a flow chart illustrating the manner in which performance of multiple actions on objects during a single traversal is facilitated according to aspects of the present disclosure.

FIG. 6 is a block diagram illustrating the manner in which performance of multiple actions during a single traversal of all objects in a bucket is enabled in one embodiment.

FIG. 7 depicts the schema of a scan data maintained to track the status and progress of multiple scans in one embodiment.

FIG. 8 is a sequence diagram illustrating the manner in which multiple scan workers continue making progress by storing state in scan table, in the event of a failure in one embodiment.

FIG. 9 is a block diagram illustrating the details of digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

Aspects of the present disclosure are directed to lifecycle management (LCM) of objects maintained in a multi-tenant object storage. In one embodiment, a (scheduler) system picks a bucket of objects corresponding to a tenant, the bucket containing objects belonging to the tenant. The system scans sequentially the objects in the (picked) bucket to determine a target object that requires an LCM action to be performed and adds the target object to a set of target objects. The system continues the scanning and the adding until a count of objects in the set of target objects equals a threshold (N). The system then marks the set of target objects for LCM processing.

It may be appreciated that the system processes the objects in the bucket only until N (threshold) target objects (that is, actions) are found, instead of processing all of the objects in each bucket. Such a strategy prevents the workload (objects, buckets, LCM policies) of any single customer/tenant from monopolizing the system and allows equitable processing for all customers/tenants (providing for fairness to the multiple tenants).

According to another aspect of the present disclosure, for the picking (noted above) the system selects a random tenant from multiple tenants as the tenant and then selects a random bucket from a set of buckets belonging to the selected tenant as the picked bucket (to be processed).

Such random selection of the tenant ensures that any deterministic patterns that may consistently place certain tenants at the end of processing is avoided, while the random selection of the bucket ensures that any problematic (“poison pill”) buckets that may consistently cause crashes do not block the progress in processing of the other buckets (adding to providing fairness to the multiple tenants).

According to one more aspect of the present disclosure, the system identifies a set of LCM policies specified by the tenant for the bucket, each LCM policy specifying a corresponding condition and a respective LCM action to be performed when an object satisfies the corresponding condition. As such, the system determines (during the scanning) a specific object as being the target object if the specific object satisfies the corresponding condition of any LCM policy contained in the set of LCM policies, the respective action specified in such LCM policy representing the LCM action.

According to yet another aspect of the present disclosure, the system performs the (actions of) picking, scanning, adding, and continuing until all of the buckets contained in the object storage are processed according to respective sets of LCM policies specified by the multiple tenants. As such, multiple sets of target objects, including the set of target objects (noted above), are marked for LCM processing.

According to an aspect of the present disclosure, the system (when adding noted above) also indicates the LCM action for the target object. The system stores the multiple sets of target objects in a persistent queue (e.g., database) and implements a corresponding worker thread for each LCM action, wherein each worker thread is designed to independently fetch objects indicated corresponding to an LCM action from the persistent queue and perform the corresponding LCM action on the fetched objects.

Such an implementation decouples the scanning (noted above) and action processes (worker threads), allowing each to operate independently and more efficiently. By having dedicated worker threads for corresponding LCM actions, efficiencies may be realized if a specific LCM action (e.g., bulk delete) permits optimizations when processing multiple target objects.

According to another aspect of the present disclosure, the system splits the objects in the (picked) bucket into multiple partitions, each partition containing a corresponding set of objects and then processes (scan, add, continue actions noted above) in parallel, the multiple partitions to find the set of target objects for the picked bucket.

Splitting the bucket into smaller units for parallel processing improves scan efficiency, reduces bottlenecks and ensures that the scanning work is distributed evenly across available resources. Such an approach in turn avoids starvation of any bucket or tenant and ensures fair processing across all buckets of all tenants.

According to one more aspect of the present disclosure, for processing in parallel, the system uses a scan controller to initiate multiple partition scans corresponding to multiple buckets including the picked bucket, with the scan controller performing the splitting noted above. The system also executes multiple scan workers, each scan worker designed to perform the (above noted actions of) scanning, adding, and continuing for each object in a corresponding partition of the multiple partitions (of the picked bucket). The system maintains a scan data to track the status and progress of each of the scans.

According to an aspect of the present disclosure, a (digital processing) system receives a bucket of objects and a set of LCM policies, each LCM policy specifying a corresponding condition and a respective LCM action to be performed when an object satisfies the corresponding condition. The system splits the objects in the received bucket into multiple partitions, each partition containing a corresponding set of objects. For each partition, the system (A) traverses sequentially the corresponding set of objects in the partition to determine a next object, (B) checks whether the next object satisfies the corresponding condition of any LCM policy contained in the set of LCM policies, and if the next object satisfies the corresponding condition, (C) applies the respective LCM action specified in the LCM policy on the next object. The traversing, checking, and applying for a first partition are performed in parallel to the traversing, checking, and applying for a second partition, the first partition and the second partition being contained in the multiple partitions.

According to another aspect of the present disclosure, the bucket contains objects belonging to a tenant, with the set of LCM policies being specified by the tenant. A set of metrics related to the next object is captured such that upon completion of processing of all of the objects in the bucket, the set of metrics is used for storage metering for the tenant. As such, storage metering and LCM of objects in the bucket are both performed during a single traversal of all objects in the bucket.

According to one more aspect of the present disclosure, for applying (noted above), the system stores the next object associated with the respective LCM action in a persistent queue. The system implements a set of worker threads for each LCM action, with each worker thread being designed to independently fetch objects corresponding to an LCM action from the persistent queue and perform the corresponding LCM action on the fetched objects.

According to yet another aspect of the present disclosure, the system uses a scan controller to initiate multiple scans corresponding to the multiple buckets including the received bucket (noted above). The scan controller performs the splitting of the bucket into partitions. Multiple scan workers are executed, each scan worker designed to perform the (above noted) actions of traversing, checking, applying and capturing for each object in a corresponding partition of the multiple partitions. A scan data is maintained to track the status and progress of the multiple scans.

According to an aspect of the present disclosure, the scan data is maintained in a scan table. Upon determining, by the scan controller based on the scan data, that the scan of a partition previously performed by a scan worker has failed, the execution of another scan worker is initiated to perform the (failed) scan of the partition.

According to another aspect of the present disclosure, the scan controller uses a combination of round-robin, priority-based scheduling and randomness in the initiation of the multiple partition scans.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

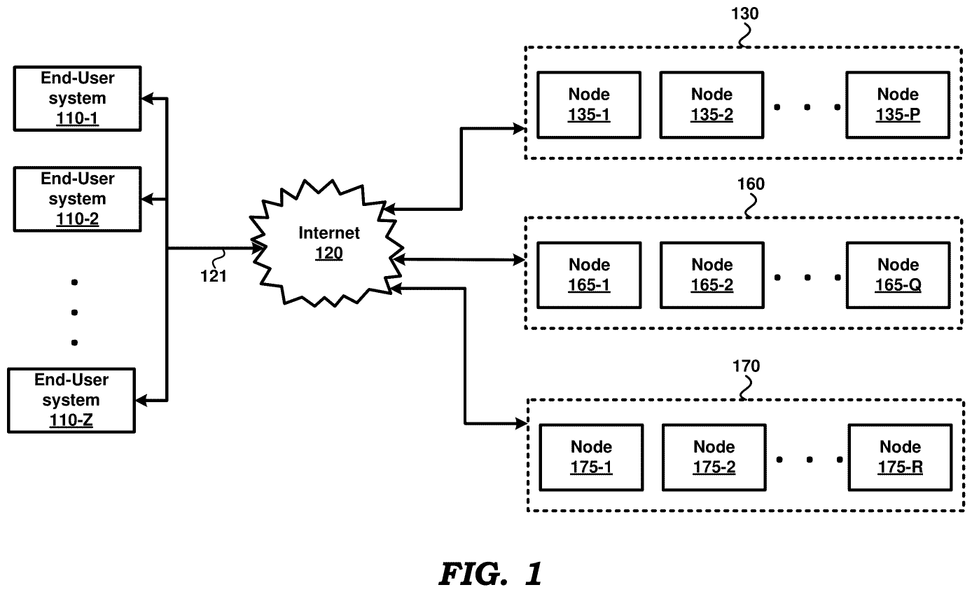

FIG. 1 is a block diagram illustrating an example computing environment in which several aspects of the present disclosure can be implemented. The block diagram is shown containing end-user systems 110-1 through 110-Z (Z representing any natural number), Internet 120, and computing infrastructures 130, 160 and 170. Computing infrastructure 130 in turn is shown containing nodes 135-1 through 135-P (P representing any natural number). Computing infrastructure 160 in turn is shown containing nodes 165-1 through 165-Q (Q representing any natural number). Computing infrastructure 170 in turn is shown containing nodes 175-1 through 175-R (R representing any natural number). The end-user systems and nodes are collectively referred to as 110, 135, 165 and 175 respectively.

Merely for illustration, only representative number/type of systems are shown in FIG. 1. Many environments often contain many more systems, both in number and type, depending on the purpose for which the environment is designed. Each block of FIG. 1 is described below in further detail.

Each of computing infrastructures 130, 160 and 170 is a collection of physical processing nodes (135, 165 and 175), connectivity infrastructure, data storages, administration systems, etc., which are engineered to together host application/data services. For illustration, the aspects of the present disclosure are described below with respect to application services, though the same aspects can be applied to data services as well as will be apparent to one skilled in the relevant arts by reading the disclosure herein.

Computing infrastructure 130/160/170 may be a cloud infrastructure such as Amazon Web Services (AWS) available from Amazon. com, Inc., Azure available from Microsoft Corporation, Google Cloud Platform (GCP) available from Google LLC, Oracle Cloud Infrastructure (OCI) available from Oracle Corporation, etc. that provides a virtual computing infrastructure for various customers/tenants, with the scale of such computing infrastructure being specified often on demand. Alternatively, computing infrastructures 130/160/170 may also correspond to an enterprise system (or a part thereof) on the premises of the customers (and accordingly referred to as “On-prem” infrastructure). Computing infrastructures 130/160/170 may also be a “hybrid” infrastructure containing some nodes of a cloud infrastructure and other nodes of an on-prem enterprise system.

All the systems of each computing infrastructures 130/160/170 are assumed to be connected via a corresponding intranet (not shown). Internet 120 extends the connectivity of these (and other systems of the computing infrastructures) with external systems such as end-user systems 110. Each of the intranets (not shown) and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and respective intranet. When the packet contains content such as port numbers, which specifies a target application, the packet may be said to be directed to such application as well.

Each of end-user system 110 represents a system such as a personal computer, workstation, mobile device, computing tablet, etc., used by users to generate (user) requests directed to application services executing in computing infrastructures 130/160/170. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system 110 requests an application service for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or application service, with the IP packet including data identifying the desired tasks in the payload portion.

Some of nodes 135/165/175 may be implemented as corresponding data stores. Each data store represents a non-volatile (persistent) storage facilitating storage and retrieval of data by application services executing in the other systems/nodes of computing infrastructures 130/160/170. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 135/165/175 may be implemented as corresponding server systems. Each server system represents a server, such as a web/application server, constituted of appropriate hardware, executing application/data services capable of performing one or more tasks. The tasks may be specified as part of user requests received from end-user systems 110 or node requests received from nodes of same/other computing infrastructures.

A node/server system, in general, receives a task request (user request or node request) and performs the tasks requested in the task request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting system (end-user system 110 or node 135/165/175) as a corresponding response to the task request. The results may be accompanied by specific user interfaces (e.g., web pages) for displaying the results to a requesting user.

In one embodiment, each customer/tenant is provided with a corresponding virtual computing infrastructure (referred to as a “cloud”) provisioned on the nodes of computing infrastructures 130, 160 and 170. The virtual infrastructure typically contains virtual resources that are one or more of computing resources (e.g., virtual machines, operating systems hosted on VMs), network resources (e.g., public IP addresses) and storage resources (e.g., object storage, database systems, file systems). Each tenant may deploy desired application/data services on the virtual resources provided as a part of their cloud(s), with the services being capable of processing user requests received from end-user systems 110.

The manner in which clouds may be deployed for multiple tenants across nodes 135, 165 and 175 in computing infrastructures 130, 160 and 170 is described below with examples.

### 3. Multi-Tenant Clouds and Object Storage

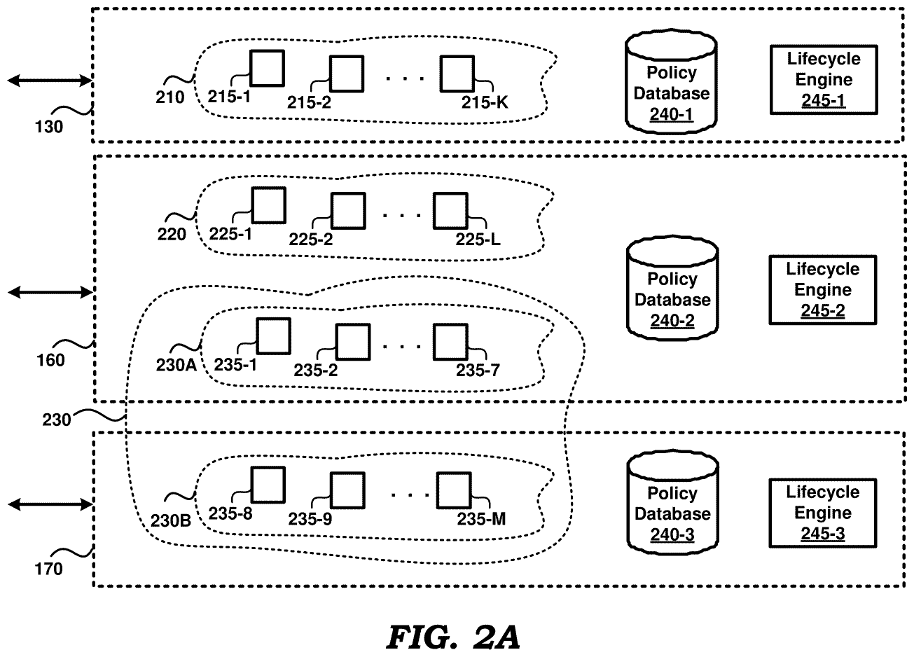

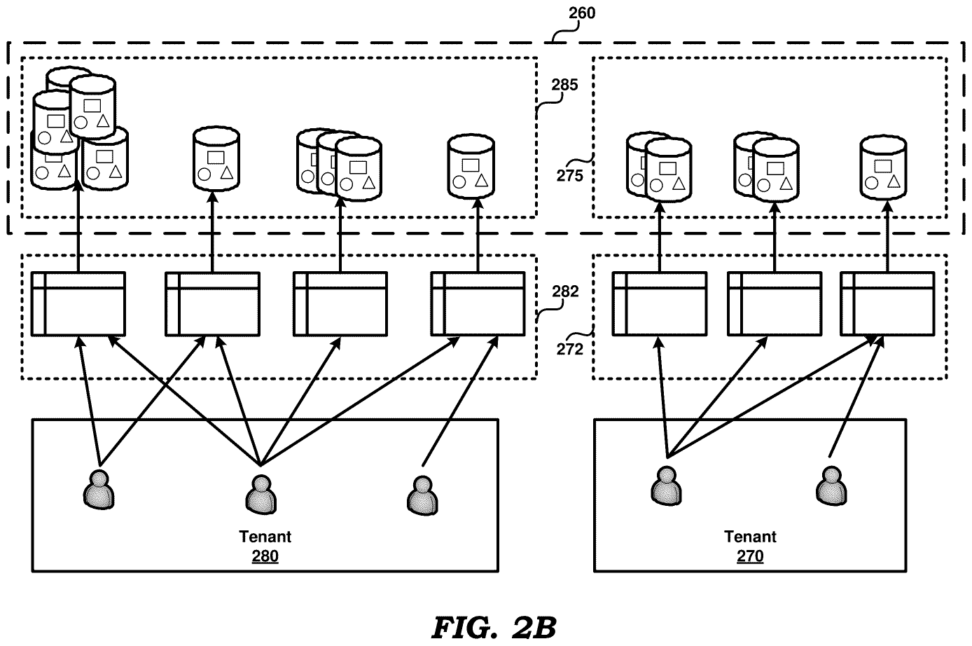

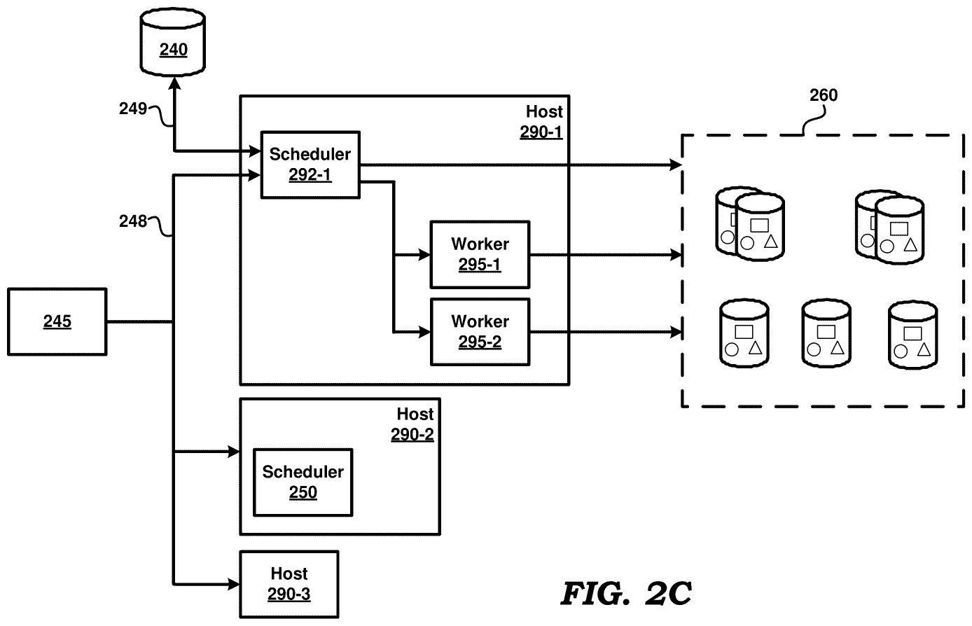

FIG. 2A illustrates the manner in which clouds for multiple tenants are deployed across nodes of computing infrastructures in one embodiment. Specifically, the Figure illustrates the manner in which clouds 210, 220 and 230 are deployed in the nodes of computing infrastructures 130/160/170 using virtual resources. Only a sample set of clouds is shown in FIG. 2A for illustration, though many environments often host a large number (100+) clouds across multiple computing infrastructures.

Cloud 210 is shown containing virtual resources 215-1 through 215-K (K representing any natural number) that may be provisioned on the different nodes 135 of computing infrastructure 130, while cloud 220 is shown containing virtual resources 225-1 through 225-L (L representing any natural number) that may be provisioned on the different nodes 165 of computing infrastructure 160.

Cloud 230 is shown containing virtual resources 235-1 through 235-M (M representing any natural number) provisioned on some of nodes 165 and 175. Cloud 230 may accordingly be viewed as a “hybrid” cloud provisioned across the nodes of multiple computing infrastructures (160 and 170). Specifically, groups 230A and 230B respectively represents the set of virtual resources provisioned in computing infrastructures 160 and 170.

A customer/tenant owning a cloud (such as 210, 220 Or 230) may deploy desired user applications for execution in their cloud. The customer/tenant may also store their data in the form of one or more objects in their cloud, while also specifying desired lifecycle management (LCM) policies for the stored objects. In the following description, the term object lifecycle management (OLM) policy is used to refer to an LCM policy specified for objects.

A cloud provider that facilitates multiple tenants to maintain their respective clouds is also required to implement these OLM policies on behalf of the tenants. An example of such a cloud provider is Oracle Cloud Infrastructure (OCI) available from Oracle Corporation. The manner in which a cloud provider may implement the OLM policies is described in detail below.

Each of policy databases 240-1 to 240-3 (collectively referred to as policy database 240) stores the OLM policies specified by the corresponding tenants for their objects. It may be appreciated that each policy database may maintain the OLM policies for different tenants as well. For example, policy database 240-1 may maintain the OLM policies for tenants of both clouds 220 and 230.

Each of lifecycle engine (LE) applications 245-1 to 245-3 (collectively referred to as LE application 245) is designed to retrieve the OLM policies from the corresponding policy database 240 and to apply the retrieved policies on the objects stored for the corresponding tenants. The manner in which tenants may store objects and specify corresponding OLM policies is described in detail below.

FIG. 2B illustrates the manner in which multiple tenants are enabled to store objects in their clouds in one embodiment. Object storage 260 represents a shared resource that facilitates tenants to store their relevant data in the form of one or more objects. In other words, object storage 260 maintains objects on behalf of multiple tenants, with the objects being viewed as part of their clouds. Object storage 260 represents one or more of nodes 135, 165 and 175 (implemented as corresponding data stores) in computing infrastructures 130, 160 and 170.

In the following disclosure, the term “bucket” refers to a collection of objects belonging to a single tenant. Such a collection may be defined by administrative requirements (e.g., objects of the same tenant but in different regions/zones are considered as different buckets) or may be specified by the tenant (e.g., to indicate different OLM policies for the objects in the different buckets). All the objects belonging to a single tenant may be considered as a single bucket as well. Object storage 260 is shown containing buckets 275 maintained on behalf of tenant 270 and buckets 285 maintained on behalf of tenant 280.

Each of tenants 270 and 280 is shown having corresponding users who may use end-user systems 110 to store objects in respective buckets 275 and 285 respectively. It should be noted that users of a tenant (270) have access to the objects in their buckets (275), but do not have access to the objects in other buckets (285) belonging to other tenants (280).

The users of each tenant 270/280 may also specify desired storage policies (indicated respectively as 272 and 282) for managing the life cycle of their stored objects. As noted above, users may specify policies that transition objects across various storage-tiers or delete the objects. Users may also assign a policy with many rules and filters based on object names. The OLM policies may be specific for each bucket or may be a common set of policies that are to applied for all objects of the tenant. OLM policies 272 and 282 is maintained in policy database 240.

The manner in which a cloud provider may implement OLM policies on behalf of the tenants is described in detail below.

FIG. 2C illustrates the manner in which lifecycle management of objects is implemented in one embodiment. Lifecycle engine (LE) application 245 is responsible for processing all the OLM policies across all objects of all tenants. In one embodiment, LE application 245 distributes the buckets (in object storage 260) to multiple systems referred to as hosts 290-1 to 290-3, with each host assigned a corresponding set of buckets to process. The description is continued with the internals of host 290-1, though the other hosts may be similarly implemented as will be apparent to one skilled in the relevant arts.

Host 290-1 is shown containing scheduler 292-1 that receives (via path 248) the set of buckets to process from LE application 245 and first selects one of the buckets for processing. Scheduler 292-1 retrieves (via path 249) from policy database 240 the OLM policies specified for the selected bucket, and then sequentially lists the objects in the bucket while also evaluating all the rules (1000+) specified in each OLM policy against each listed object. Such evaluation may entail checking whether the rules/conditions are satisfied for the listed object, and if satisfied forwarding the listed object to one of workers 295-1/295-2 which in turn performs the appropriate LCM action (move, archive, delete, etc.) on the listed object.

Each of workers 295-1/295-2 represents an application that is capable of performing any of the LCM actions, and operates independently from other workers and scheduler 292-1. Though only a sample number of workers is shown in the Figure, typical implementations may have a smaller/larger number of workers as will be apparent to one skilled in the relevant arts.

Thus, a cloud provider facilitates lifecycle management of objects maintained in a multi-tenant object storage (260). However, as noted in the Background section, there are several challenges to such an implementation of OLM policies in a multi-tenant architecture as described below with examples.

### 4. Challenges to Lifecycle Management of Objects

### Increased Workload for Hosts

As noted above, OLM is implemented using a simple design—list all objects of the bucket, evaluate all the rules (conditions & actions) in each OLM policy against each object and take actions triggered by the rules. However, such a design may not be adequate to handle the increased amount of workload (number of objects, number of buckets, number OLM policies) and thereby cause severe delays for multiple customers/tenants. Some of the use cases that may cause increased workload are:
Old buckets with new OLM policies—For example, a new OLM policy on old buckets (like logging for internal service team) may have a lot of actions to perform. The sudden introduction of such a policy may slow down processing for all other customers whose buckets are being processed on the same host.
Too many OLM-enabled buckets for a customer (>10K default)—OLM is handled by distributing the buckets across multiple hosts. Increasing the number of buckets may cause redistribution of the buckets and slow down the processing of the existing buckets.
Humongous versioned buckets (>1 billion objects)—Versioned delete, and archival actions are taken on individual object versions usually take a longer time (~200 ms) to complete. It may be desirable that alternative operations such as BatchDelete be used (which typically takes ~6 ms per object) to significantly improve the throughput of OLM processing.

### Scalability Issues

There are several scenarios that can affect the scalability of the simple design noted above. Some of such scenarios are:
Noisy-neighbor scenarios—Due to “unfair” scheduling policy (selecting which buckets to process at what corresponding times), the increased workload of a single customer may introduce delays in processing of other customers on that same host. Adding to the complexity is that workloads in a multi-tenant environment may be unpredictable leading to contention points.
Uneven workload distribution—Multiple large buckets may be assigned to the same host, increasing operational burden and causing processing delays.

### Object Listing Blockage

In one embodiment, multiple thread pools are used to handle various tasks (scheduler 292-1, worker threads 295-1, 295-2, etc.) related to OLM. Each thread pool is implemented using a blocking thread pool executor, which has the characteristic of blocking threads that are submitting tasks when the queue is full and no threads are available in the pool to execute these tasks. In other words, when action queues (worker threads 295-1, 295-2) are full, the blocking executor blocks any additional tasks from being submitted. Consequently, when any of these action queues are full, scheduler 292-1 cannot submit new actions. This blocking behavior restricts scheduler 292-1 from listing new objects. As a result, the host (290-1) may experience a significant reduction in its ability to list objects or object versions, due to the backlog of pending actions for any one target object. This cascading effect limits the overall throughput of the system.

### Unbalanced Workload Distribution

Unbalanced workload distribution across hosts (290-1, 290-2, etc.) may arise in the distribution of buckets to the multiple hosts, due to the following reasons:
Bucket Size Variability: Not all buckets are of equal size. Some buckets contain a significantly larger number of objects compared to others.
Action Density: Buckets with a higher density of actions (such as delete, archive, update tier) require more processing resources.

When large buckets or those requiring many actions are assigned to a single host, the processing load on that host may increase disproportionately. It may be noted that simply distributing the buckets across hosts by the number of objects evenly also does not ensure even workload distribution. Even though same number of objects are processed by each host, the number of actions performed by the hosts may vary largely.

### Fair Scheduling Policy

From a customer perspective, service level objective (SLO) for object lifecycle management may be to perform any applicable actions within 24 hours upon maturity of the object (that is, when the object becomes eligible for the action (deletion/update tier) to take place). Accordingly, a scheduling policy may be required to ensure fairness between tenants (inter-tenant) and within tenants (intra-tenant). Currently, a round-robin approach, evaluating one bucket from each tenant before moving to the next, provides weak fairness guarantees at least in view of the size of individual buckets, varied sizes of different buckets, and action density among the different buckets.

Implementing fairness at the listing level may lead to adverse consequences. A customer with a large workload may block the listing process for other customers with smaller workloads. In each processing cycle, the customer with the large workload is prioritized, blocking others from getting their listings and actions processed. Despite using a round-robin scheduling policy, the system may struggle to fully utilize hardware resources due to varying actions across hosts. Listing gets blocked when the action queue is full, limiting the lifecycle engine's processing capabilities during high-action periods. This inadvertently leads to a “noisy neighbor” scenario where the large workload of one customer blocks the processing of the workloads of other customers.

### Objectives to be Met

Overall, from the above, it may be appreciated that OLM faces bottlenecks in two phases of its operations: a) Listing and b) Actions executed. Accordingly, it is desirable that improvement be achieved in both phases, while also meeting the following objectives as well:
Maximize the number of tenancies that have all their buckets processed within their SLOs. When a customer suddenly turns on OLM on a massive bucket, their SLO may be missed/not satisfied. However, such an action should not affect satisfying the SLOs of the other customers.
Maximize the number of buckets within a tenancy that are processed within SLO.

Referring again to FIG. 2C, scheduler 250 (shown executing in host 290-2), provided according to several aspects of the present disclosure, performs lifecycle management of objects maintained in a multi-tenant object storage (260) while overcoming the challenges noted above. The manner in which scheduler 250 performs lifecycle management of objects is described below with examples.

### 5. Performing Lifecycle Management of Objects

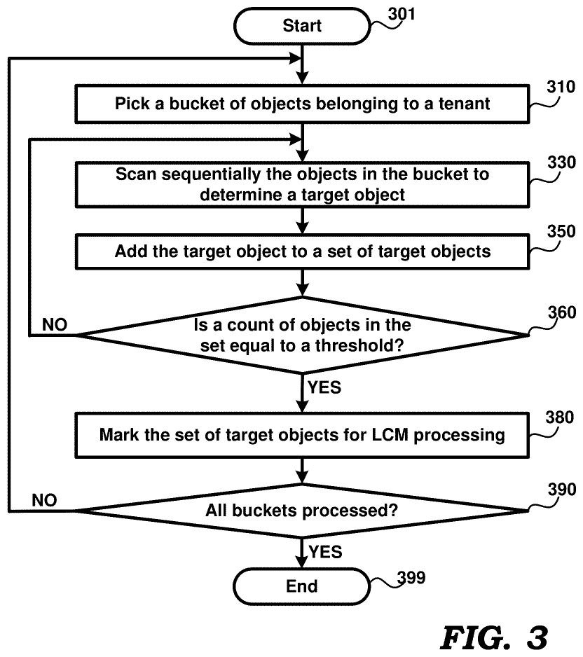

FIG. 3 is a flow chart illustrating the manner in which lifecycle management of objects maintained in a multi-tenant object storage (260) is facilitated according to aspects of the present disclosure. The flowchart is described with respect to the systems of FIGS. 1 and 2, in particular scheduler 250, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, scheduler 250 picks a bucket of objects belonging to a tenant for OLM processing. According to an aspect, scheduler 250 first selects a random tenant from the set of tenants as the picked tenant and then selects a random bucket from a set of buckets belonging to the picked tenant as the picked bucket.

In step 330, scheduler 250 scans sequentially the objects in the picked bucket to determine a target object that requires an LCM action to be performed. It may be noted that scanning sequentially causes the listing of the objects in the bucket, and may be performed based on an order (ascending/descending) of the values of some of the attributes such as last modified datetime, created datetime, identifier, etc. The determination may entail checking whether a current object being listed satisfies any of the conditions in the LCM policies specified by the picked tenant. The scan may be temporarily suspended upon determination of the target object.

In step 350, scheduler 250 adds the (determined) target object to a set of target objects. The set may be maintained in a known way, for example, as a list of identifiers of the target objects, as will be apparent to one skilled in the relevant arts.

In step 360, scheduler 250 checks whether a count of objects in the set (of target objects) is equal to a threshold (any desired natural number N). Control passes to step 330 if the count is less than the threshold, whereby scheduler 250 resumes the scan (from the next object succeeding the target object) to determine the next target object in the picked bucket. Steps 330, 350 and 360 are continued to be repeated until the count equals the threshold, whereupon control passes to step 380.

In step 380, scheduler 250 marks the set of target objects for LCM processing. Such marking may entail storing the set/list of target objects in a memory, or forwarding the set to another process/application for further LCM processing.

In step 390, scheduler 250 checks whether all the buckets (in object storage 260) have been processed. If all the buckets have not being processed, control passes to step 310, where scheduler 250 picks up another bucket (of the same/different tenant) for processing and steps 330 (scanning), 350 (adding), and 360 (checking and continuing) are performed with respect to another bucket. Once all buckets have been processed, control passes to step 399, where the flowchart ends.

Thus, scheduler 250 facilitates lifecycle management of objects maintained in a multi-tenant object storage (260). It may be appreciated that scheduler 250 lists objects until N actions (that is, target objects) are found, rather than listing a fixed number of objects for all tenants and buckets (as would be done by scheduler 292-1). Such a strategy ensures fair resource allocation, preventing the workload of any single customer from monopolizing the system and allowing equitable processing for all customers.

In this regard, it may be noted that listing operations are relatively cheaper (in terms of hardware/software resources used) compared to actions like delete or update tier, which involve metadata updates. Ensuring fairness at the action level (instead of at the listing level) in general provides for a fairer system that allows every customer a chance to execute the same number of actions, resulting in—More actions processed for all tenants during an bucket processing cycle (flowchart of FIG. 3); and Prevention of “noisy neighbor” scenarios. The manner in which scheduler 250 provides several aspects of the present disclosure according to the steps of FIG. 3 is described below with examples.

### 6. Scheduler Operation

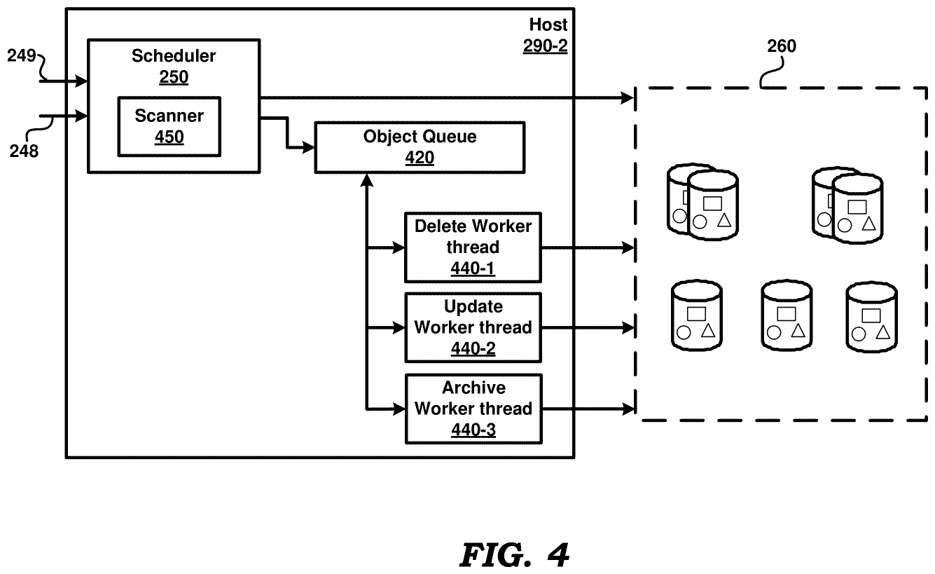

FIG. 4 is a block diagram illustrating the manner in which lifecycle management of objects maintained in multi-tenant object storages is facilitated in one embodiment. The block diagram is shown containing scheduler 250, object queue 420, and worker threads 440 (including delete worker thread 440-1, update worker thread 440-2 and archive worker thread 440-3)—all of which are shown executing in host 290-2 for illustration. Each block of the Figure is described below in further detail.

Scheduler 250 receives (via path 248) the set of buckets to process from LE application 245 and first picks one of the buckets for processing. Specifically, scheduler 250 first selects a random tenant from the set of tenants as the tenant and then selects a random bucket from a set of buckets belonging to the tenant as the picked bucket. As noted above, such random selection of the tenant ensures that any deterministic patterns that may consistently place certain tenants at the end of processing is avoided, while the random selection of the bucket ensures that any problematic (“poison pill”) buckets that may consistently cause crashes do not block the progress in processing of the other buckets.

In one embodiment, within each tenant, the order of the buckets is randomized by the fact that different buckets complete at different times each day. Over time, randomization will bring other non-problematic buckets to the start of the scan, allowing the system (of FIG. 4) to move forward even if some buckets consistently fail.

Scheduler 250 then retrieves (via path 249) OLM policies from policy database 240, and identifies a set of LCM policies specified by the picked tenant for the picked bucket. As is well known, each LCM policy specifies a corresponding condition and a respective LCM action to be performed when an object satisfies the corresponding condition.

Each condition is typically a logical expression containing attributes of the objects, values, and logical operators, which upon evaluation returns a Boolean value (true or false). Examples of such conditions may be last_modified_datetime<=TODAY, created_datetime>1 MONTH, etc. where TODAY, MONTH, etc. are pre-defined values. Evaluation of the condition typically entails substituting the attributes in the condition with the actual values specified in the object, and then checking whether the condition is satisfied (true) or not (false). The actions may be one of archive, delete, update tier, etc. as will be apparent to one skilled in the relevant arts.

Scheduler 250 then performs a sequential scan of the objects in the picked bucket until a set of target objects (corresponding to N actions) is found. During the scan, scheduler 250 determine that a specific object as being the target object if the specific object satisfies the corresponding condition of any LCM policy contained in the set of LCM policies, with the respective action specified in such LCM policy representing the LCM action. According to an aspect, scheduler 250 stores the set of target objects in object queue 420.

Object queue 420 represents a non-volatile/persistent queue storing objects for LCM processing, each stored object being associated with the specific LCM action to be performed on the object. In one embodiment, object queue 420 is stored in a database. Each of worker threads 440 represents an application that operates independently and is designed to perform a single LCM action (e.g., delete, update). The dedicated worker threads for each action (such as delete worker thread 440-1 for deletion, update worker thread 440-2 for update and archive worker thread 440-3 for archiving) are designed to independently fetch target objects (associated with the action) from object queue 420 and perform the corresponding LCM action on the fetched objects. It should be noted that the worker threads 440 are implemented independent of the bucket and the tenant.

It may be observed that the implementation noted above decouples the listing (scheduler 250) and action processes (worker threads 440), allowing each to operate independently and more efficiently. Persisting mature actions in a database (420) ensures that they are not lost and can be accessed by any available host, improving the resilience and overall throughput of the system. In addition, replacing the previously used shared in-memory queue with a persisted queue stored in the database (420) reduces the contention between listing and action threads. The use of dedicated worker threads for each LCM action type ensures that resources are utilized effectively and prevents bottlenecks.

According to an aspect, scheduler 250 performs the sequential scanning/listing of objects by first splitting the objects in the (picked) bucket into multiple partitions, each partition containing a corresponding set of objects. Scheduler 250 then processes in parallel, the multiple partitions to determine the set of target objects for the picked bucket (which may thereafter be stored in object queue 420). As noted above, splitting the bucket into smaller units for parallel processing improves scan efficiency, reduces bottlenecks and ensures that the scanning work is distributed evenly across available resources. This in turn avoids starvation of any bucket or tenant and ensure fair processing across all buckets of all tenants.

According to another aspect, such parallel processing of partitions enables performance of multiple actions during a single traversal of all objects in a bucket as described below with examples.

### 7. Performing Multiple Actions on Objects During a Single Traversal

In the following disclosure, the multiple actions to be performed on objects is assumed to be storage metering which tracks the space usage of objects in buckets and OLM which applies bucket lifecycle policies for automatic object transitions and deletions. However, in alternative embodiments, other actions may be performed during the single traversal as will be apparent to one skilled in the relevant arts by reading the disclosure herein.

As is well known, storage metering refers to the process of capturing relevant metrics per bucket across different storage tiers (such as Archive, Infrequent Access, and Standard). The captured/metered values represent the usage of the virtual resources by the customer/tenant and accordingly are used to bill the customer/tenant for their resource usage. At a high-level, the metrics needed may be categorized as follows: Per bucket metrics such as total size of the bucket and number/count of objects in the bucket, Object (Versioned) Count, per storage tier, Storage bytes (Committed Uploads), per storage tier, Part Storage Bytes (Uncommitted), per storage tier, Unbilled Objects (for accurate billing), per storage tier, Unbilled Storage Bytes (for accurate billing), per storage tier.

It may be noted that both of storage metering and OLM are bucket-centric. Since scanning all objects in a bucket is expensive (in terms of resource usage) as compared to other bucket related operations and given the large number of buckets, possibly a large number of objects in a single bucket and the need to meet strict SLOs, it may be desirable that storage metering and OLM be performed together during a single traversal.

Such a scanning may need to meet one or more requirements of (a) scan each bucket exactly once per day; (b) avoid starvation of any bucket or tenant and ensure fair processing across all buckets of all customers; (c) ensure that scanning work is distributed evenly across available resources; (d) complete one bucket scan before moving to the next bucket (This is necessary for accurate billing); and (e) Checkpoint scans on a bucket so that they can be resumed if a scan is interrupted (failure/crash).

Scanner 450 (shown executing in scheduler 250), provided according to several aspects of the present disclosure, facilitates the performance of multiple actions (OLM and storage metering) on objects during a single traversal as described below with examples.

### 8. Scanning a Bucket of Objects

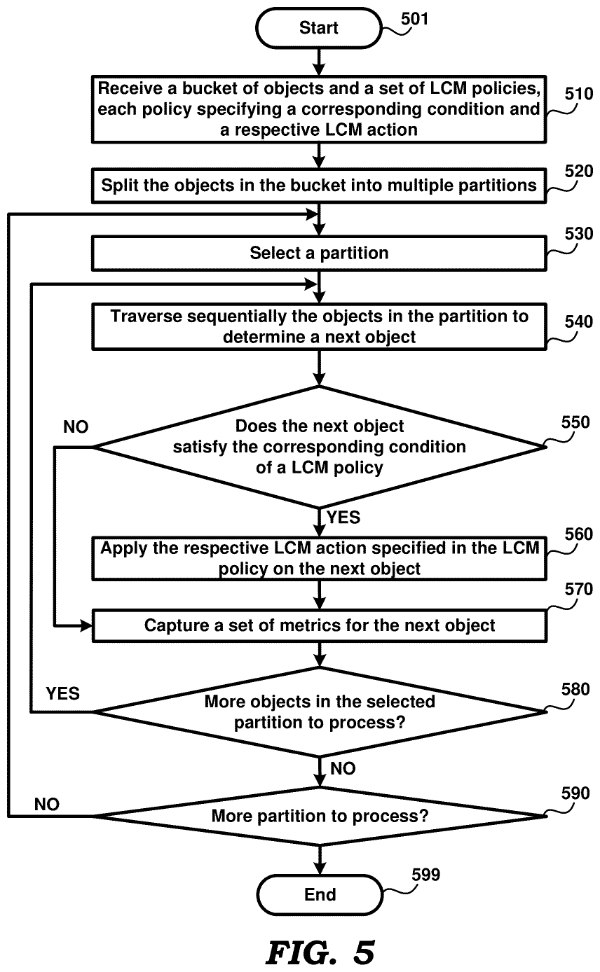

FIG. 5 is a flow chart illustrating the manner in which performance of multiple actions on objects during a single traversal is facilitated according to aspects of the present disclosure. The flowchart is described with respect to the system of FIGS. 1 and 2, in particular scanner 450, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 501, in which control immediately passes to step 510.

In step 510, scanner 450 receives a bucket of objects and a set of LCM policies, each policy specifying a corresponding condition and a respective LCM action. According to an aspect, received bucket is the (picked) bucket belonging to the picked tenant, with the set of LCM policies being specified by the tenant.

In step 520, scanner 450 splits the objects in the received bucket into multiple partitions. The term “partitions” used herein refers to non-overlapping sets of objects, and may be specified using the unique identifiers of the objects.

In step 530, scanner 450 selects a partition for processing. The selection may be performed in a known way. For example, a flag may be associated with each of the partitions, with the flag of a partition indicating whether the partition has already been processed (when the flag is set to a first value) or not (when the flag is set to a second value). The selection of the partition may entail choosing a partition whose flag is set to the second value.

In step 540, scanner 450 traverses sequentially the objects in the partition to determine a next object. The traversal may be performed using a current object pointer to track the objects already processed, with the current object pointer being set to the first object in the partition, and thereafter moved one object at a time, until the last object in the partition is processed, as will be apparent to one skilled in the relevant arts.

In step 550, scanner 450 checks whether the next object satisfies the corresponding condition of any LCM policy in the received set of LCM policies. The checking of whether the next object satisfies the condition may be performed similar to the checking performed by scheduler 250, and accordingly the description is not repeated here for conciseness. Control passes to step 560 if the next object satisfies the condition, and to step 570 otherwise.

In step 560, scanner 450 applies the respective LCM action specified in the LCM policy on the next object. Such “applying” of the respective LCM action may entail marking the next object as a target object, storing the next object and respective LCM action in a persistent queue (such as 420) such that dedicated worker threads (such as 440) may thereafter fetch the target objects and perform the respective LCM action on the fetched objects. Control passes to step 570.

In step 570, scanner 450 captures a set of metrics (such as those noted above) for the next object. Such capturing may entail updating the values of different counters (size, number, etc.) required for calculating the metrics, as will be apparent to one skilled in the relevant arts.

In step 580, scanner 450 determines whether there are more objects in the selected partition to process. The determination may be performed based on whether the current object counter is pointing to the last object or not. Control passes to step 540 if there are more objects to be processed in the selected partition, whereby steps 540, 550, 560 and 570 are performed for another next object in the selected partition. Control passes to step 590 after all the objects in the selected partition have been processed.

In step 590, scanner 450 checks whether there are more partitions to process. The checking may be performed based on the flag associated with each partition. Control passes to step 530 if there are more partitions to process, that is when there exists at least one partition whose flag is set to the second value. Once all partitions are processed, control passes to step 599, where the flowchart ends.

According to an aspect, the steps of 530 through 580 for a first partition is performed in parallel to the steps of 530 through 580 for a second partition. In other words, though the flowchart shows the performance of processing of objects in each partition as being sequential, in actual implementation they are performed in parallel using multiple scan workers as described in detail in the below sections.

It may be appreciated that upon completion of processing of all of the objects in the bucket, the set of metrics captured in step 570 is used for storage metering for the tenant, while the steps of 550 and 570 perform the OLM of all objects in the bucket. As such, storage metering and LCM of objects in the bucket are both enabled to be performed during a single traversal of all objects in the bucket.

It may be further appreciated that leveraging a single scanner for both storage metering and OLM reduces redundant scanning processes which in turn may save operational overhead, simplify maintenance, and provide a single source of truth for scanning activities across services. In addition, stopping billing for objects as soon as they become eligible for OLM deletion provides customers with a predictable and fair experience. This may resolve a common complaint about OLM in large buckets, where customers are billed for objects even after deletion (in view of the delay in the execution of OLM).

The manner in which scanner 450 may be implemented to provide several aspects of the present disclosure according to the steps of FIG. 5 is described below with examples.

### 9. Scanner Implementation

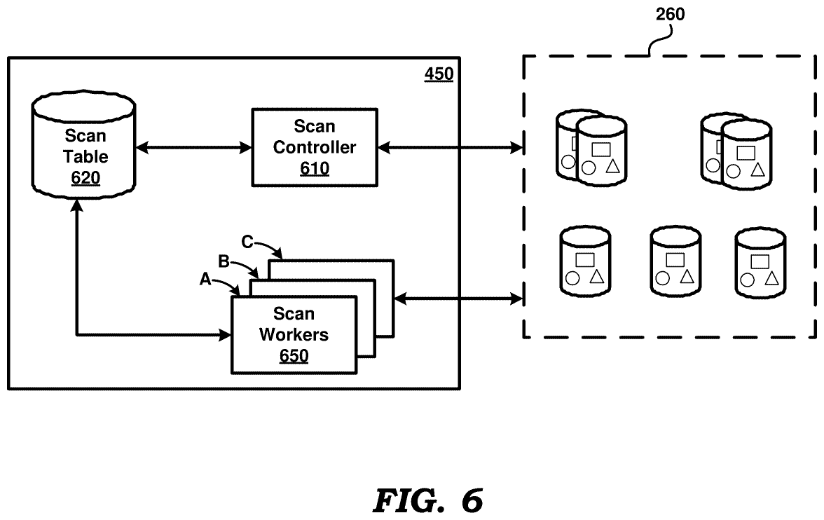

FIG. 6 is a block diagram illustrating the manner in which performance of multiple actions during a single traversal of all objects in a bucket is enabled in one embodiment. The block diagram is shown containing scan controller 610, scan table 620, and scan workers 650 (including A, B and C)—all of which are shown implemented in scanner 450 for illustration. Each block of the Figure is described below in further detail.

Scan controller 610 is responsible for and initiating and managing the scans for all buckets (one scan for one bucket) that are required to be processed. Scan controller 610 splits the objects in each bucket into several partitions (typically, equal to the number of scan workers 650) and then have all scan workers 650 traverse a different partition of the bucket. Such a technique provides maximum concurrency to a large bucket and allows all scan workers to be “equally” dividing the scan workload. The scanning process involves scanning all partitions of a bucket, handling large-scale concurrency, ensuring fairness across buckets, and mitigating the risk of starvation, all while maintaining scalability.

Scan controller 610 is also responsible for scheduling the various scans. In one embodiment, scan controller 610 uses a fixed-interval scheduling with backoff (which is relatively simple to implement). However, in alternative embodiments, scan controller 610 may use dynamic interval scheduling or event-driven scheduling (such as the arrival of a new bucket, a high-priority scan request combined with a token bucket mechanism to limit bursts, etc.) In addition, scan controller 610 may be designed to adjust the scan interval dynamically based on system metrics, such as the number of pending scans, CPU utilization, or memory usage. For instance, scan controller 610 may run more frequently during high demand periods or back off during quieter times.

Each scan may be in one of four states: READY—The bucket is ready to be scanned, but the partitions have not been created yet; IN_PROGRESS—The scan for the bucket is actively being processed by scan workers, or it will be picked up by next available scan worker; DONE—All partitions of the scan have been successfully completed; and FAILED—The scan could not complete with specified number of retries. Scan controller 610 is also responsible for aggregating completed partition results for currently (executing) scans and cleaning up outdated scan records stored in scan table 620.

Thus, scan controller 610 is responsible for orchestrating the overall scanning process by scheduling scans across tenants and buckets, managing scan states, and handling failure recovery. Scan controller 610 ensures that no tenant or bucket is starved and that all bucket/partition scans eventually complete, even in the event of failures. Scan controller 610 also manages fairness using a combination of round-robin mechanism and priority-based scheduling coupled with randomization to avoid starvation and resource monopolization. Scan controller 610 maintains all the scan metadata in scan table 620.

Scan table 620 represents a non-volatile/persistent storage (such as a table in a database) that maintains scan data/metadata that tracks the status and progress of each of the multiple scans (sought to be performed on corresponding buckets). An example schema of the scan data that may be maintained in scan table 620 is described below with examples.

### 10. Scan Data Schema

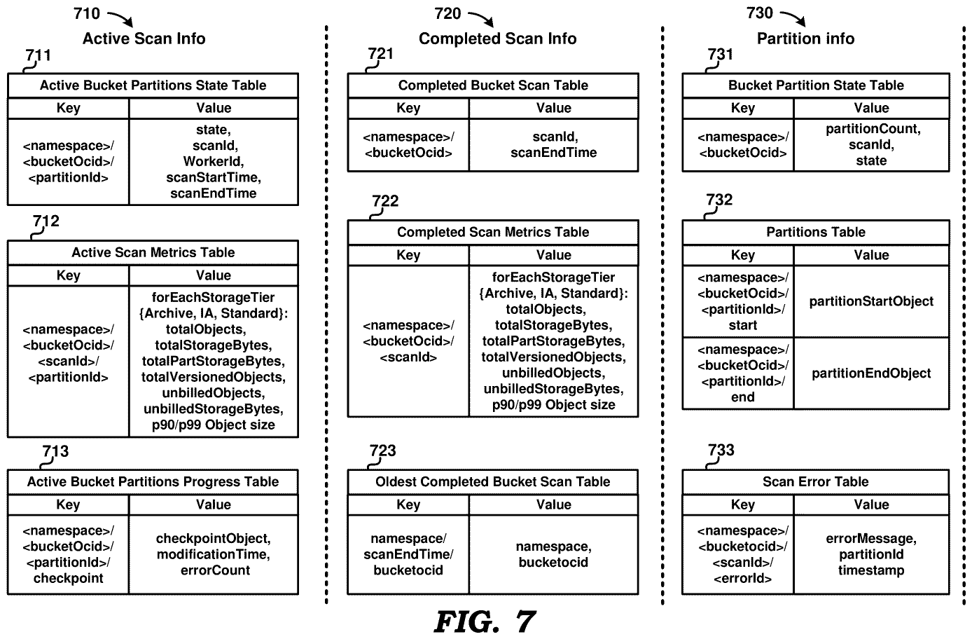

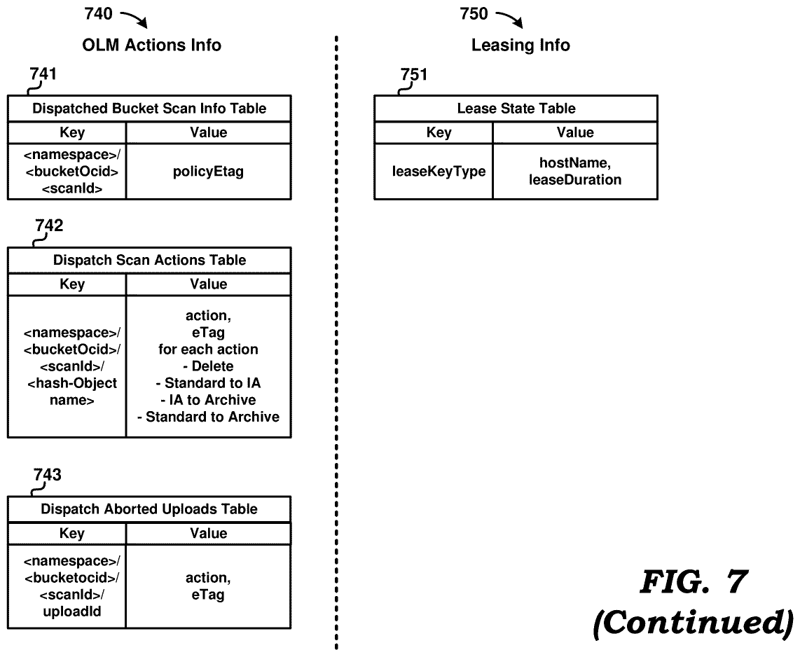

FIG. 7 depicts the schema of a scan data maintained to track the status and progress of multiple scans in one embodiment. Broadly, the schema for the scanner (450) captures essential data required for fault tolerance, efficient scanning, and seamless integration with other system components. Some of the key elements of the schema are described in detail below.

### Active Scan Information (710)

Active Bucket Partitions State Table 711 records the current state of each bucket partition during an active scan, enabling the system to resume from where it left off in case of failures. Active Scan Metrics Table 712 captures detailed metrics by storage tier (e.g., Archive, IA, Standard) for each partition during an active scan, including object counts, storage sizes, and object size percentiles. Active Bucket Partitions Progress Table 713 tracks progress for each partition by recording checkpoint details, modification times, and error counts, ensuring efficient scan recovery and checkpointing.

### Completed Scan Information (720)

Completed Bucket Scan Table 721 records the completion time and scan ID for each completed bucket scan, enabling historical tracking of scan events. Completed Scan Metrics Table 722 stores final metrics for completed scans by storage tier, similar to the Active Scan Metrics Table 712, for performance tracking and historical analysis. Oldest Completed Bucket Scan Table 723 maintains a record of the oldest completed scan per bucket, ordered by scan end time, to support efficient retrieval based on scan history.

### Partition Information (730)

Bucket Partition-State Table 731 tracks the state and partition count of each bucket, along with the latest scan ID, helping manage bucket partitions for scanning and other operations. Partitions Table 732 defines the start and end object boundaries for each partition, essential for managing the scanning range within each bucket. Scan Error Table 733 logs errors encountered during scans, including error messages, partition IDs, and timestamps, facilitating debugging and retries for failed scan operations.

### OLM Actions Information (740)

Dispatched Bucket Scan Info Table 741 tracks dispatched lifecycle actions for each bucket scan, using the policy ETag to ensure correct and consistent lifecycle processing. Dispatch Scan Actions Table 742 logs specific lifecycle actions (e.g., delete, transitions between storage tiers) for each object in the bucket, including the action type and eTag, supporting retries and accurate lifecycle management. Dispatch Aborted Uploads Table 743 records lifecycle actions for aborted uploads, helping manage incomplete uploads in line with lifecycle policies.

### Lease Management (750)

Lease State Table 751 tracks the active lease status of each host acting as a controller or scan worker, ensuring high availability and fault tolerance. If a host holding a lease becomes unresponsive, another host can take over the controller role.

The final output of each scan includes comprehensive metrics for every bucket, stored for analysis and further processing. The schema of FIG. 7 also includes tables dedicated to tracking and managing lifecycle actions, ensuring that transitions and deletions are reliably executed and retried if necessary. The description is continued with the manner in which the scan data stored in scan table 620 is used for performing the traversals of the different partitions of a bucket in one embodiment.

### 11. Scan Workers

Referring again to FIG. 6, each of scan workers 650 handles the actual scanning of each bucket/bucket partition. Each scan worker is designed to retrieve object metadata, apply the scan logic (check if object satisfies a condition, capture metrics, etc.), and updates scan results (mark objects for LCM action, update counters maintained for the metrics, etc.). If a failure occurs during the scan, the system ensures that the scan can resume or restart safely. The operation of a scan worker (assumed to be 650A) is described below for illustration, though similar operation is performed by the other scan workers (650B and 650C) as well as will be apparent to one skilled in the relevant arts by reading the disclosure herein.

During normal operation, scan worker 650A chooses a bucket partition for traversal and as such first chooses a bucket based on priority, having the oldest timestamp, etc. (as described in below sections). Once the bucket is chosen, scan worker 650A iterates through all partitions in Active Bucket Partitions State Table 711 and finds a random partition and checks if it is in READY state to begin the scan. Scan worker 650A marks the state as IN PROGRESS and updates modification time to current time. If there is a partition with state IN PROGRESS, but its modification time is older than the scan time per bucket, then it can be assumed that this partition is not being processed by any scan worker because the previous scan worker's lease to this partition ended.

Scan worker 650A then lists objects, versions and uploads in the chosen partition. The listing of the objects may be performed in a known way, using the partition start, end range as start prefix and the endKey to control listing end. Scan worker 650A may also perform checkpointing, where the scan worker checks if the elapsed time since the last modification exceeds the configured checkpoint frequency, and if so, updates Active Bucket Partition Progress Table 713. Specifically, scan worker 650A may check that no other scan worker has updated this record, update the checkpointObject to record the last scanned object for the partition, ensuring resumption from the correct point if necessary, and store the accumulated storage metering information, ensuring each partition's object counts and storage usage are saved for the current storage tier. Scan worker 650A also updates Active Bucket Partitions State Table 711 with the overall progress for the bucket, including the total partition count, scan start time, and any unauthorized status if permissions issues were encountered.

Scan worker 650A also dispatches lifecycle actions. As scan worker 650A lists the objects/versions/uploads, scan worker 650A also checks if the listed object is eligible for any lifecycle actions based on predefined rules (such as transitions or deletions based on object age, storage tier, etc.). The lifecycle policy for a bucket may be retrieved from policy database 240. Rule evaluation may follow the existing criteria: Filter buckets without OLM policies, disabled or empty OLM rules; Filter buckets with retention rules; and Filter read-only buckets.

If an LCM action is eligible, scan worker 650A checks if the object already exists in Dispatch Scan Actions Table 842 and inserts a record for the object if not present. The inserted record may include Key: Namespace, bucket name, and the object name and Value: action type (delete, transition to IA/Archive) and current eTag of the LCM policy. Storing namespace and bucket name is essential in Key so that the action worker threads (such as 440-1 to 440-3) are enabled to filter actions for specific namespace and buckets to allow fairness while executing. All objects eligible for delete should not be included in billing, and accordingly may be tracked under unbilledObjectCount and unbilledStorageBytes. When reporting usage as part of storage metering, the unbilled count/size is subtracted from the computed total count/size so that customers stop getting charged as soon as the objects are deleted by OLM.

If any error occurs while scanning a partition, scan worker 650A records the error details in Scan Error Table 733, including: Namespace, bucket OCID, partition count, error ID, error message, and timestamp. The errorCount in the scan is also updated. After logging the error, scan worker 650 may retry the partition a certain number of times (configurable). If the scan of the partition still fails after the configured number of retries, scan worker 650A may move on to the next partition and leave the current one marked as failed in Scan Error Table 733 for manual intervention.

On the other hand, if scan worker 650A crashes/dies, the bucket partition is picked up by another available scan worker (such as 650B/650C) which first checks for the modification time of the scan. The new scan worker will resume scanning from the last checkpoint. The objects missed in the checkpoint will be re-scanned (hence the importance to maintain period checkpointing). In addition, each scan worker also maintains a lease timeout for each bucket partition. If the scan is in progress, then the next scan worker waits for the lease duration to see any update to the scan state. If there is no update for lease duration, an available scan worker acquires the lease and starts scanning the bucket.

After the completion of a scan of a partition, scan worker 650A computes relevant statistics (such as object count, storage tier distribution) and updates the status of the bucket partition. Scan worker 650A may then move to the next bucket partition and repeat the above noted process.

Thus, scan workers 650 perform the actual traversal and processing of buckets, split into multiple partitions. The manner in which scan workers 650 operate together with other components of FIG. 6 to facilitate performance of multiple actions on the objects during a single traversal of all objects in a bucket is described below with examples.

### 12. Scanner Operation

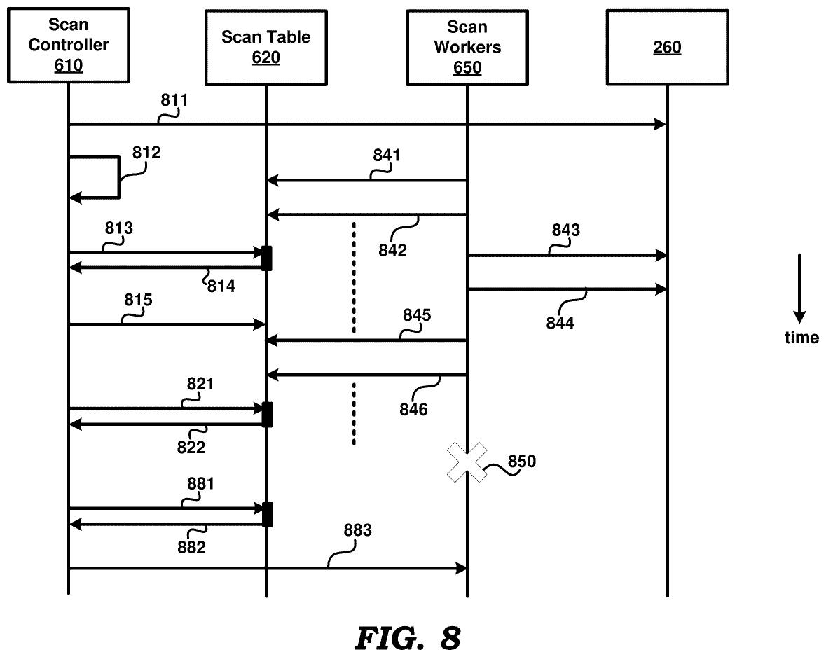

FIG. 8 is a sequence diagram illustrating the manner in which multiple scan workers continue making progress by storing state in scan table, in the event of a failure in one embodiment. At 811, scan controller 610 periodically lists all namespaces to load or update the in-memory cache of tenancies and their metadata from object storage 260.

At 812, scan controller selects a bucket to process for the tenant and moves on to the next tenant. The selection of the bucket may be performed in any desired manner. For example, a configuration parameter listing the highest priority buckets to be processed may be maintained. As such, scan controller 610 may first select the buckets specified in the list. Once all buckets from this list are processed, then the buckets may be selected based on their last scan time, prioritizing buckets with the oldest timestamp to ensure fairness. Such an approach minimizes the risk of starvation, as no bucket can avoid being scanned for too long.

In one embodiment, the selection of the bucket is based on the data in the Oldest Completed Bucket Scan Table 723 which maintains the timestamp of scan end times of completed buckets. It may be noted that if the previous scan of a bucket was marked failed, the scanEndTime column is set to a very old timestamp to ensure that the bucket gets picked at the next available scan time.

At 813/814, scan controller 610 checks whether any existing scan of the selected bucket is being performed. Specifically, scan controller 610 checks the current state of the bucket scan in Bucket Partition State Table 731. If no entry exists in the table, scan controller 610 creates an entry in READY state. If the scan state is READY (indicating that no partitions have been created yet), scan controller 610 proceeds to partition creation (described below) and inserts the partitions in Partitions Table 732, and then update the state of bucket in same table to IN_PROGRESS.

If the scan state is IN_PROGRESS (indicating that the bucket scan is ongoing/will be picked up/completed, scan controller 610 checks if all the partitions are completed. If all partitions are not completed, no further action is performed by scan controller 610. However, if all partitions are completed, scan controller 610 performs aggregation of the results (described below) and inserts the results to Completed Bucket Scan Table 721. An entry in Oldest Completed Bucket Scan Table 723 is atomically inserted along with the entry in Completed Bucket Scan Table 721. If the scan state is DONE, scan controller 610 gets the scanId of the recently completed scan and checks whether the scanEndTimes is within the scan Interval (typically, 24 hours). If not within the scan interval, scan controller 610 updates the Bucket Partition State Table 731 with a new ScanId and the scan state as READY.

The description is continued assuming that at 814, scan controller 610 determined that scan state is READY. Scan controller 610 accordingly perform partition creation by first getting the size of the selected bucket (from example, from previous completed scan) and determining the number of partitions (partitionCount) for a bucket using a pre-defined max size of a partition. The Partition Table 732 is used to track each partition of the bucket and record the scan state for each partition. It may be appreciated that there should not be gaps in (start, end) partition ranges for each bucket, that is, the start of partition 2 range should match the end of partition 1 range. A null value may be assigned to the start and end ranges for the first and last partitions respectively.

At 815, scan controller 610 inserts a new entry in Bucket Partition State Table 731 corresponding to each partition (range), followed by updating the state of the bucket in Active Bucket Partitions Progress Table 713 to be READY and assigning the appropriate partitionList to uniquely identify this entry. Also, scan controller 610 inserts entries into the Active Bucket Partitions State Table 711 corresponding to each partition with state READY, and finally, updates state of bucket in Bucket Partition State Table 731 to IN_PROGRESS.

At 821/822, scan controller 610 determines that scan state is IN_PROGRESS and that all the partitions in the bucket are completed. Accordingly, scan controller 610 aggregates all the results from the processing of the partitions and marks the bucket as complete and updates the Completed Bucket Scan Table 721 with the aggregated information (at 823). The scanEndTime is the maximum scan completion time of all partitions of the bucket. In one embodiment, insertion is done by inserting the metrics for scan Id first and then updating the scan Id corresponding to the bucket. Scan controller 610 also inserts an entry in the Oldest Completed Bucket Scan Table 723 with the reverse timestamp of the scan end.

In general, scan controller 610 ensures that only one scan for a bucket partition is active at any time; every bucket in every namespace should be scanned at least once every 24 hours; every scan is only one of the four scan states noted above; each scan should support resumability via checkpoints, enabling the scan to continue from the last processed object; and all scan workers must maintain a consistent view of the scan state, meaning that no two scan workers can work on the same bucket partition simultaneously. The manner in which failures of scan controller 610 and scan workers 650 are handled is descried below with examples.

### 13. Failure Handling

It may be appreciated that in the scenario that scan controller 610 crashes/dies, upon restart, scan controller 610 repeats the above noted scheduling operations starting from 811. It may be noted that scans for buckets can safely be restarted or retried without risking duplicate work or errors. The manner in which failure of scan workers 650 is handled is described in detail below.

At 841, one of scan workers 650 (assumed to be 650A) leases/chooses partitions based on the scan data maintained in scan table 620. At 842, scan worker 650A starts the scan of the chosen partition and updates scan table 620 as noted above. At 843 and 844, scan worker 650A retrieves objects contained in the chosen partition from object storage 260 and performs the scanning logic (that is, traversing the objects in the partition). At 845, scan worker 650A adds a checkpoint to scan table 620 as described above, and at 846 continues the scanning of the other objects in the chosen partition. It is assumed that at 850, scan worker 650A crashes/dies, whereby the traversing of the chosen partition is interrupted (in other words, the scan of the partition failed).

At 881/882, scan controller 610 checks scan table 620 to determine that the traversal of a partition performed by a scan worker (650A) has failed. At 883, scan controller 610 initiates execution of another scan worker (650B) to perform the (failed) partition traversal.

Thus, failures of scan controller 610 and scan workers 650 are handled by the system. However, it should be noted that only a single scan controller 610 is shown as implemented in scanner 450, and as such becomes a single point of failure (with proper alarming). However, in alternative embodiments, a more distributed model with multiple scan controllers may be implemented, ensuring high availability and avoiding a single point of failure as will be apparent to one skilled in the relevant arts by reading the disclosure herein.

Such a multi-controller architecture may enable the controller work to be distributed across hosts. In the embodiment described herein, a single dynamic controller 610 is used to perform the splitting of buckets and initiating of the bucket/partition scans. If scan controller 610 dies, then another host can become the scan controller using the controller leasing mechanism described in detail below.

In the controller leasing mechanism, only one active process holds the “lease” at any given time, representing its authority to act as the scan controller (610). If the current controller goes offline or fails to renew its lease, a different process can acquire the lease and assume the role of scan controller 610.

In one embodiment, a ScheduledGetLeaseHeartbeatService on each host interacts with the Lease State Table 751 to attempt to acquire or renew a lease. When a process (such as a thread) becomes the controller or scan worker, the process writes an entry into the Lease State Table 751 with its hostname, lease type, and lease expiration time. Each time the lease is renewed, the expiration time in the Lease State Table 751 is updated. In the event a process fails to renew its lease (e.g., due to network issues, crash, or high load), the lease will eventually expire based on the leaseDuration in the Lease State Table 751. Other processes monitoring the Lease State Table 751 and are eligible to acquire a lease if the lease has expired. The Lease State Table 751 thus enables quick identification of an available lease and seamless takeover by another host/process.

Thus, the controller leasing mechanism handles failures of both scan controller and scan workers. By ensuring that the information on any expired lease is made available to other hosts/ processes, the other processes are enabled to attempt to acquire the expired lease. This ensures rapid recovery and minimizes downtime for the controller and scan workers. The description is continued with the manner in which the system ensures fairness across various buckets and tenants.

### 14. Providing Fairness

It may be appreciated that in general, the design of the system ensures fairness by always prioritizing buckets that have not been scanned for the longest time. This minimizes the risk of starvation, where certain buckets are neglected while others are scanned more frequently. By using the last scan timestamp as the primary criterion for bucket selection, the system guarantees that every bucket will eventually be scanned in a cyclical manner.

Additionally, the splitting of large buckets (into partitions) ensures that no single bucket scan can monopolize the resources of the system, which would otherwise starve smaller buckets from being scanned. Scanning each partition independently allows for balanced workload distribution among available worker nodes. The goal of such as design is to ensure that scan controller 610 makes progress, even in the presence of consistently problematic buckets that could cause crashes, such as those containing a large number of objects.

Specifically, the picking of a combination of a random tenant and a random bucket of the random tenant guarantees that the system continues making progress, even in the event of repeated failures for particular buckets. Buckets that do not cause failures will eventually be scanned, ensuring that the overall system remains responsive and no bucket is left behind indefinitely.

The system is designed to scale across multiple workers and hosts. The partitioning of large buckets and concurrent scanning across hosts ensure that scans can be performed efficiently even as the number of buckets and objects grows. Furthermore, if a host crashes, the controller redistributes the work by assigning unscanned partitions to other available workers, thus maintaining the continuity of the scan without overloading any single worker.

Furthermore, the system operates in a best-effort manner, meaning there is no strict SLA for scan completion but rather a guarantee of eventual progress. The system scales horizontally by adding more workers to handle concurrent scans, ensuring that performance and reliability are not compromised as the scale increases. The tables (620) allow the system to manage millions of objects and buckets, keeping track of each individual scan across partitions.

It should be further appreciated that the features described above can be implemented in various embodiments as a desired combination of one or more of hardware, software, and firmware. The description is continued with respect to an embodiment in which various features are operative when the software instructions described above are executed.

### 15. Digital Processing System

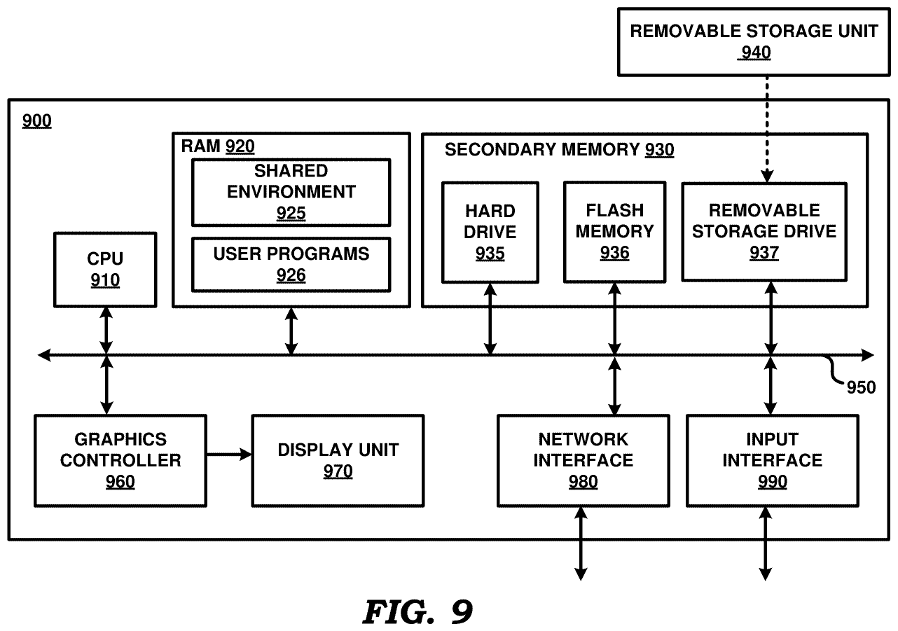

FIG. 9 is a block diagram illustrating the details of digital processing system (900) in which various aspects of the present disclosure are operative by execution of appropriate executable modules. Digital processing system 900 may correspond to scheduler 250 or any system (such as host 290-1) executing scheduler 250.

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions constituting shared environment 925 and/or other user programs 926 (such as other applications, DBMS, etc.). In addition to shared environment 925, RAM 920 may contain other software programs such as device drivers, virtual machines, etc., which provide a (common) run time environment for execution of other/user programs.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems connected to the networks.

Secondary memory 930 may contain hard drive 935, flash memory 936, and removable storage drive 937. Secondary memory 930 may store the data (e.g., according to the schema shown in FIG. 7) and software instructions (e.g., for performing the actions of FIGS. 3 and 5, for implementing the blocks of FIGS. 2A-2C, 4 and 6, performing the actions of FIG. 8), which enable digital processing system 900 to provide several features in accordance with the present disclosure. The code/instructions stored in secondary memory 930 may either be copied to RAM 920 prior to execution by CPU 910 for higher execution speeds, or may be directly executed by CPU 910.

Some or all of the data and instructions may be provided on removable storage unit 940, and the data and instructions may be read and provided by removable storage drive 937 to CPU 910. Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

### 16. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

1: A method for lifecycle management (LCM) of objects maintained in an object storage on behalf of tenants, the method comprising:
picking a first bucket of objects corresponding to a first tenant, said first bucket containing objects belonging to said first tenant;
scanning sequentially the objects in said first bucket to determine a target object that requires an LCM action to be performed;
adding said target object to a set of target objects;
continuing said scanning and said adding until a count of objects in said set of target objects equals a threshold; and
marking said set of target objects for LCM processing.

2: The method of claim 1, wherein said picking comprises:
selecting a random tenant from a plurality of tenants as said first tenant; and
selecting a random bucket from a first set of buckets belonging to said first tenant as said first bucket.

3: The method of claim 2, further comprising:
identifying a first set of LCM policies specified by said first tenant for said first bucket, each LCM policy specifying a corresponding condition and a respective LCM action to be performed when an object satisfies the corresponding condition,
wherein said scanning determines a first object as said target object if said first object satisfies said corresponding condition of a first LCM policy contained in said set of LCM policies, said respective action specified in said first LCM policy representing said LCM action.

4: The method of claim 3, further comprising performing said picking, said scanning, said adding and said continuing until all of a plurality of buckets contained in said object storage are processed according to respective sets of LCM policies specified by said plurality of tenants,
wherein a plurality of sets of target objects, including said set of target objects, are marked for LCM processing.

5: The method of claim 4, wherein said adding also indicates said LCM action for said target object, said method further comprising:
storing said plurality of sets of target objects in a persistent queue; and
implementing a set of worker threads for each LCM action, wherein each worker thread is designed to independently fetch objects corresponding to an LCM action from said persistent queue and perform the corresponding LCM action on the fetched objects.

6: The method of claim 1, further comprising:
splitting the objects in said first bucket into a first plurality of partitions, each partition containing a corresponding set of objects; and
processing in parallel, said first plurality of partitions to find said set of target objects for said first bucket.

7: The method of claim 6, wherein said processing in parallel comprises:
using a scan controller to initiate a plurality of scans corresponding to a plurality of buckets including said first bucket, wherein said scan controller performs said splitting;
executing a plurality of scan workers, each scan worker designed to perform said scanning, said adding, and said continuing for each object in a corresponding partition of said first plurality of partitions; and
maintaining a scan data to track the status and progress of said plurality of scans.

8: A non-transitory machine-readable medium storing one or more sequences of instructions for lifecycle management (LCM) of objects maintained in an object storage on behalf of tenants, wherein execution of said one or more instructions by one or more processors contained in a digital processing system cause said digital processing system to perform the actions of:
picking a first bucket of objects corresponding to a first tenant, said first bucket containing objects belonging to said first tenant;
scanning sequentially the objects in said first bucket to determine a target object that requires an LCM action to be performed;
adding said target object to a set of target objects;
continuing said scanning and said adding until a count of objects in said set of target objects equals a threshold; and
marking said set of target objects for LCM processing.

9: The non-transitory machine-readable medium of claim 1, wherein said picking comprises:
selecting a random tenant from a plurality of tenants as said first tenant; and
selecting a random bucket from a first set of buckets belonging to said first tenant as said first bucket.

10: The non-transitory machine-readable medium of claim 9, further comprising one or more instructions for:
identifying a first set of LCM policies specified by said first tenant for said first bucket, each LCM policy specifying a corresponding condition and a respective LCM action to be performed when an object satisfies the corresponding condition,
wherein said scanning determines a first object as said target object if said first object satisfies said corresponding condition of a first LCM policy contained in said set of LCM policies, said respective action specified in said first LCM policy representing said LCM action.

11: The non-transitory machine-readable medium of claim 10, further comprising one or more instructions for performing said picking, said scanning, said adding and said continuing until all of a plurality of buckets contained in said object storage are processed according to respective sets of LCM policies specified by said plurality of tenants,
wherein a plurality of sets of target objects, including said set of target objects, are marked for LCM processing.

12: The non-transitory machine-readable medium of claim 11, wherein said adding also indicates said LCM action for said target object, further comprising one or more instructions for:
storing said plurality of sets of target objects in a persistent queue; and
implementing a set of worker threads for each LCM action, wherein each worker thread is designed to independently fetch objects corresponding to an LCM action from said persistent queue and perform the corresponding LCM action on the fetched objects.

13: The non-transitory machine-readable medium of claim 8, further comprising one or more instructions for:
splitting the objects in said first bucket into a first plurality of partitions, each partition containing a corresponding set of objects; and
processing in parallel, said first plurality of partitions to find said set of target objects for said first bucket.

14: The non-transitory machine-readable medium of claim 13, wherein said processing in parallel comprises:
using a scan controller to initiate a plurality of scans corresponding to a plurality of buckets including said first bucket, wherein said scan controller performs said splitting;
executing a plurality of scan workers, each scan worker designed to perform said scanning, said adding, and said continuing for each object in a corresponding partition of said first plurality of partitions; and
maintaining a scan data to track the status and progress of said plurality of scans.

15: A digital processing system comprising:
a random access memory (RAM) to store instructions; and
one or more processors to retrieve and execute the instructions, wherein execution of the instructions causes the digital processing system to perform the actions of:
receiving a bucket of objects and a set of LCM policies, each LCM policy specifying a corresponding condition and a respective LCM action to be performed when an object satisfies the corresponding condition;
splitting the objects in said bucket into a plurality of partitions, each partition containing a corresponding set of objects;
for each partition of said plurality of partitions:
traversing sequentially said corresponding set of objects in the partition to determine a next object;
checking whether said next object satisfies said corresponding condition of a first LCM policy contained in said set of LCM policies;
if said next object satisfies said corresponding condition, applying said respective LCM action specified in said first LCM policy on said next object,
wherein said traversing, said checking and said applying for a first partition are performed in parallel to said traversing, said checking and said applying for a second partition, said first partition and said second partition being contained in said plurality of partitions.

16: The digital processing system of claim 15, wherein said bucket contains objects belonging to a first tenant, wherein said set of LCM policies is specified by said first tenant,
further performing the actions of capturing a set of metrics related to said next object,
wherein upon completion of processing of all of the objects in said bucket, said set of metrics is used for storage metering for said first tenant,
wherein said storage metering and LCM of objects in said bucket are both performed during a single traversal of all objects in said bucket.

17: The digital processing system of claim 16, wherein said applying comprises the actions of:
storing said next object associated with said respective LCM action in a persistent queue; and
implementing a set of worker threads for each LCM action, wherein each worker thread is designed to independently fetch objects corresponding to an LCM action from said persistent queue and perform the corresponding LCM action on the fetched objects.

18: The digital processing system of claim 15, further performing the actions of:
using a scan controller to initiate a plurality of scans corresponding to a plurality of buckets including said bucket, wherein said scan controller performs said splitting;
executing a plurality of scan workers, each scan worker designed to perform said traversing, said checking, said applying and said capturing for each object in a corresponding partition of said plurality of partitions; and
maintaining a scan data to track the status and progress of said plurality of scans.

19: The digital processing system of claim 18, wherein said scan data is maintained in a scan table, further performing the actions of:
determining, by said scan controller based on said scan data, that the scan of a first partition previously performed by a first scan worker has failed; and
initiating execution of a second scan worker to perform the scan of said first partition.

20: The digital processing system of claim 19, wherein said scan controller uses a combination of round-robin, priority-based scheduling and randomness in the initiation of said plurality of partition scans.
